(19) United States
(12) Patent Application Publication
(10) Pub. No.: US 2008/0292085 A1
(43) Pub. Date: Nov. 27, 2008

(54) Method and apparatus for automatically rejecting unauthorized telephone calls

(76) Inventor: Thomas Pappas, Scottsdale, AZ (US)

Correspondence Address: Thomas Pappas, 23644 North 84th Street, Scottsdale, AZ, 85255-3524, US

(21) Appl. No.: 12/152,825

(22) Filed: May 15, 2008

Related U.S. Application Data
(60) Provisional application No. 60/931,666, filed on May 25, 2007.

(51) Int. Cl. H04M 3/42; G06Q 30/00

(52) U.S. Cl. 379/210.02; 705/26; 705/14

(57) ABSTRACT

A data processing apparatus and method for determining whether an incoming telephone call originated from a number on a blacklist, and either hanging up on the call, or allowing the connected phone to ring through. A means of adding or deleting numbers simply with one touch of a button is implemented.

### CROSS REFERENCE TO RELATED APPLICATIONS

This application claims the benefit of provisional application Ser. No. U.S. 60/931,666 which was filed on May 15, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of home convenience, and more specifically to a method of blocking unsolicited phone calls from specified numbers. Several attempts at this capability have been marketed, but all of them required either rigorous data entry, or/or batteries, and/or had cumbersome user interfaces, limiting their user acceptance.

### BRIEF SUMMARY OF THE INVENTION

The sole object of the invention is to make it possible for a user to specify the numbers from which incoming calls will be accepted, and which rejected with a single touch of a button.

A small electronic module containing a microprocessor and storage is plugged between the telephone set and the wall outlet. This “box” contains hardware to connect the invention's circuitry to the Public Switched Telephone (PSTN) on one side, the user apparatus on the other, and internal storage and processing capability to manage the list of “black” (blocked) numbers without any further external connection.

In use, the user can press the pushbutton and the current state of the subscriber number in the device's scratchpad memory will be toggled to the opposite setting.

### DESCRIPTION OF THE PREFERRED EMBODIMENT

The present invention is concerned with providing a searchable inventory of blacklisted phone numbers, and the means to terminate the ring process by hanging up when one of these numbers is detected ringing in.

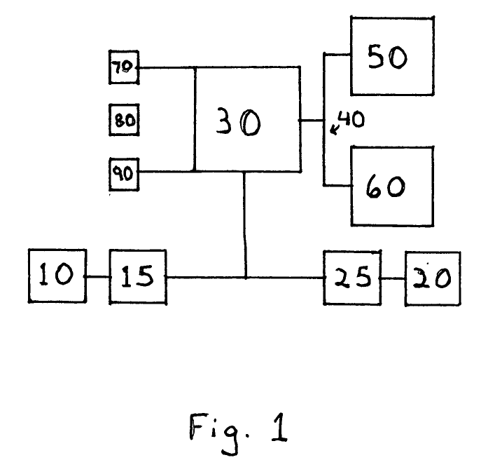

Turning to the figures, FIG. 1 is a highly generalized schematic diagram of a Home telephone installation, which consists of an optional DSL filter 15 and mandatory CallerID capture box 25 connected together through the invention 30.

In accordance with this disclosure, the data in the files of database 21 more particularly comprises an unordered list of telephone numbers and/or CID codes to which the program code can search, add or delete numbers.

Thus, a reservation system and method is disclosed, which allows clients and merchants to interact in an easy and efficient manner for facilitating and encouraging commercial transactions. The invention utilizes one or more databases of reservations and of information about the reservations that clients can search for and purchase. The system and methods of the invention are easy to employ with existing networked infrastructures and can be implemented relatively easily and at minimal cost.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A data processing apparatus for intercepting and rejecting unwanted telephone calls, said apparatus comprising:
a central controller including a CPU and a memory operatively connected to said CPU;

2. The apparatus according to claim 1, wherein said central controller receives a telephone number and stores it.

3. The apparatus according to claim 2, wherein said program in said memory is adapted to compare the stored number to a stored database of numbers.

4. A method of determining a price of an option to purchase a remnant golf greens fee using a central controller including a CPU and a memory operatively connected to said CPU and containing a program adapted to be executed by said CPU for determining the price of an option by automatically reducing the price in steps over time, starting from some initial value at some designated time, and a terminal adapted for communicating with said CPU, the method comprising the steps of:
inputting course location criterion to the controller via the terminal;
inputting tee-off time criterion to the controller via the terminal;
inputting size of party criterion to the controller via the terminal;
inputting number of holes criterion to the controller via the terminal;
inputting price criterion to the controller via the terminal; and
calculating a price of an option that gives the customer a right to purchase within a future period, for a particular price, a golf greens fee satisfying the course location criterion, the tee-off time criterion, the size of party criterion, the number of holes criterion, and the price criterion by having the CPU execute said program; and
outputting the option price to the terminal.

5. The method of determining a price of an option according to claim 4, wherein preestablished price adjustment factors are applied, viz. a time factor and a price factor that are used in conjunction to reduce the price of the option as a function of how long since it was put on sale.
